(19) United States
(12) Patent Application Publication
(10) Pub. No.: US 2001/0021979 A1
(43) Pub. Date: Sep. 13, 2001

(54) Image processing apparatus, image processing method, image processing system and storage medium

(76) Inventor: Yoshinori Ito, Tokyo (JP)

Correspondence Address: FITZPATRICK CELLA HARPER & SCINTO, 30 ROCKEFELLER PLAZA, NEW YORK, NY, 10112, US

(21) Appl. No.: 09/783,073

(22) Filed: Feb. 15, 2001

(30) Foreign Application Priority Data
Feb. 16, 2000 (JP) 2000-037923
May 31, 2000 (JP) 2000-163206

(51) Int. Cl. H04L 9/32; G06F 11/30; G06F 12/14

(52) U.S. Cl. 713/189

(57) ABSTRACT

In order to facilitate specifying a person executing illegal image formation, the invention provides an image processing apparatus connected with an information communication apparatus, comprising first input means for entering information on the addressee of fee billing from the information communication apparatus, second input means for entering an image, addition means for adding the information on the addressee of fee billing to the image in a manner not easily recognizable to the human eyes, and output means for outputting thus added image.

### BACKGROUND OF THE INVENTION

1. Field of the Invention

The present invention relates to an image processing apparatus, an image processing method, an image processing system and a storage medium.

2. Related Background Art

There is already known a color image forming apparatus such as a color copying machine which reads an original placed on an original table, outputs the read color image data to a printer unit and forming a color image by the printer unit. In such color image forming apparatus, there is already known an apparatus provided with a controller and connected with a computer network, thereby being capable of functioning as a network printer by developing image data from a terminal such as another computer in the controller and transferring the image data to the printer unit for color image formation.

In such color image forming apparatus, for preventing the forgery of banknotes or valuable papers, there is already known an apparatus provided with an ID number specific to each machine and capable of forming a dot pattern, based on the ID number and in a pale yellow color which is almost invisible to the human eyes, in superposition (add-on) with the printout image. It is thus rendered possible to specify the machine used for printing the image, by reading the printed image with an exclusive scanner and analyzing the read image.

However, the image forming apparatus such as the color copying machine has become popular year after year based on the cost reduction enabled by the technological progress, and is more and more installed in locations available to unidentified multiple users, such as convenience stores. In such situation, even if the specific machine used for printing can be identified from the printed image, it is extremely difficult to identify the person who conducted the illegal copying or printing operation. As the user of the illegal copying or printing cannot be identified from the resulting print, such illegal deed, if used under malicious intention, may result in serious personal or economical damages, and an improvement on such drawback is being longed for.

### SUMMARY OF THE INVENTION

In consideration of the foregoing, an object of the present invention is to provide an image processing apparatus, an image processing method and a storage medium capable of resolving the above-mentioned drawback.

Another object of the present invention is to provide an image processing apparatus, an image processing method, an image processing system and a storage medium allowing to facilitate the identification of the person who conducted the illegal image formation.

Still another object of the present invention is to provide an image processing apparatus, an image processing method and a storage medium capable of effective information in an image.

The above-mentioned objects can be attained, according to a preferred embodiment of the present invention, by an image processing apparatus which is connected with an information communication apparatus, comprising first input means for entering information on an addressee of fee billing from the information communication apparatus, second input means for entering an image, addition means for adding the information on the addressee of fee billing to the image in a manner not easily recognizable by the human eyes, and output means for outputting the added image.

Also according to another preferred embodiment of the present invention, there is provided an information communication apparatus which connected with an image processing apparatus and capable of communicating with an external server, comprising first input means for entering information on an addressee of fee billing and a password, first output means for outputting the information on the addressee of fee billing and the password to the external server, second output means for outputting aforementioned information for billing the fee to the image processing apparatus, according to the result of identification of the aforementioned information on the addressee of fee billing and the password in the external server, second input means for entering information based on the image output from the image processing apparatus, and third output means for outputting the aforementioned information based on the image output to the external server.

According to another preferred embodiment of the present invention, there is also provided an image processing apparatus in which a server device and a manager terminal device are capable of communication through a predetermined communication medium and which controls the execution of image processing by confirming the payment of a fee charged to a predetermined image processing, comprising a card reader for reading a card medium in which recorded is a personal identification information for identifying a person requesting the image processing, conversion means for converting the personal identification information read by the card reader into personal identification image data, image generation means for generating output image data from the personal identification image data converted by the conversion means and used-requested image data for which the aforementioned image processing is requested, and control means for limiting the image processing request by comparing the personal identification information read by the card reader and image output limitation information acquired from the server device.

According to another preferred embodiment of the present invention, there is also provided an image processing apparatus comprising input means for entering an image, input means for entering predetermined information to be embedded in the image, inquiry means for inquiring to the exterior whether the predetermined information is effective, and embedding means for embedding the predetermined information into the image in case the inquiry means identifies that the predetermined information is effective.

The present invention relates to an image processing apparatus, an image processing method, an image processing system and a storage medium having novel functions.

Still other objects of the present invention, and the features thereof, will become fully apparent from the following description of the embodiments, to be taken in conjunction with the accompanying drawings.

### BRIEF DESCRIPTION OF THE DRAWINGS

FIG. 1 is an external perspective view showing the configuration of an image processing apparatus constituting a first embodiment;

FIG. 2 is a block diagram showing an example of an image processing system in which the image processing apparatus of the first embodiment is applicable;

FIG. 3 is a block diagram schematically showing the configuration of a controller shown in FIG. 1;

FIG. 4 is a view showing an example of a sorter device optionally connectable to the image processing apparatus shown in FIG. 1;

FIG. 5 is a view showing the configuration of a card reader shown in FIG. 2;

FIGS. 6 and 7 are flow charts showing examples of a first data processing procedure in the image processing apparatus of the first embodiment;

FIG. 8 is a flow chart showing an example of a second data processing procedure in the image processing apparatus of the first embodiment;

FIG. 9 is a block diagram showing an example of an image processing system in which the image processing apparatus of the second embodiment is applicable;

FIG. 10 is a flow chart showing an example of a first data processing procedure in the image processing apparatus of the second embodiment;

FIG. 11 is a flow chart showing an example of a second data processing procedure in the image processing apparatus of the second embodiment; and

FIG. 12 is a view showing the memory map of a storage medium storing various data processing programs which are readable by an image processing system in which the image processing apparatus of the present invention is applicable.

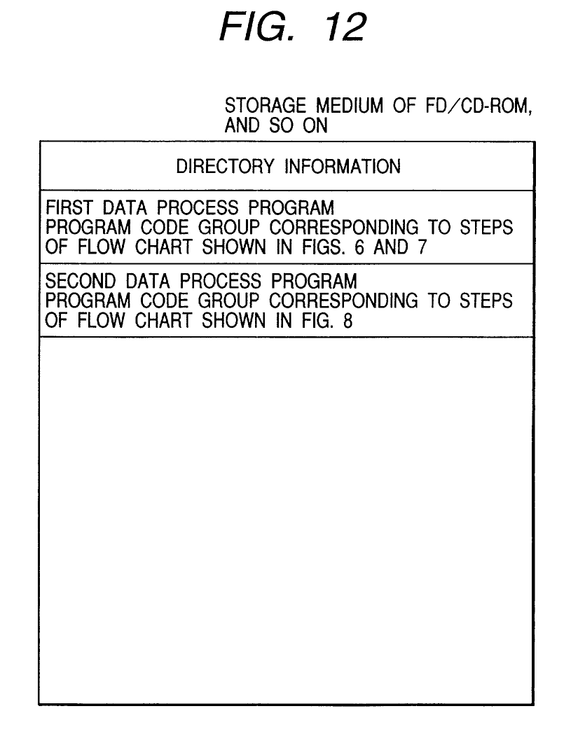

### DESCRIPTION OF THE PREFERRED EMBODIMENTS

[First Embodiment]

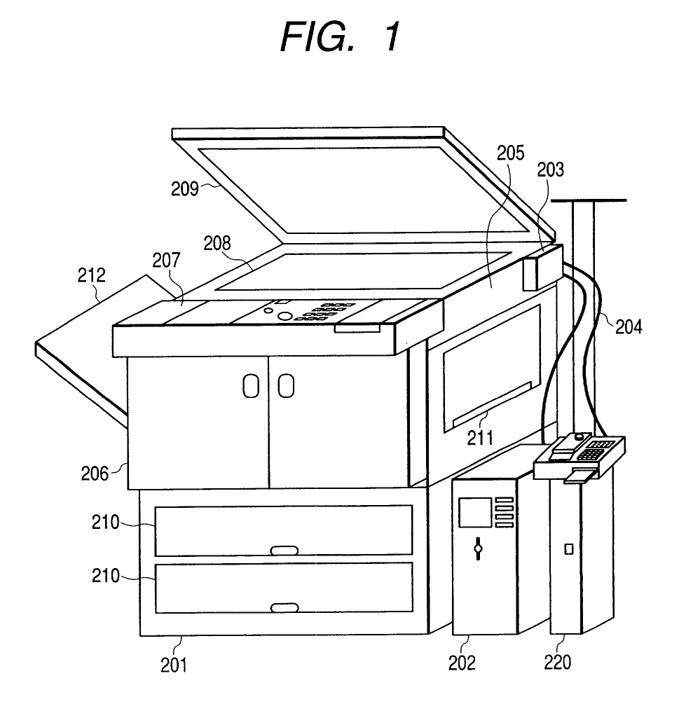

FIG. 1 is an external perspective view showing the configuration of an image processing apparatus constituting a first embodiment. A full color copying machine 201 in the first embodiment is provided with a controller 202 and is connected thereto through a video cable 204 connected to a video interface 203. The full color copying machine 201 is also provided with an accounting device 220 with an ID reader.

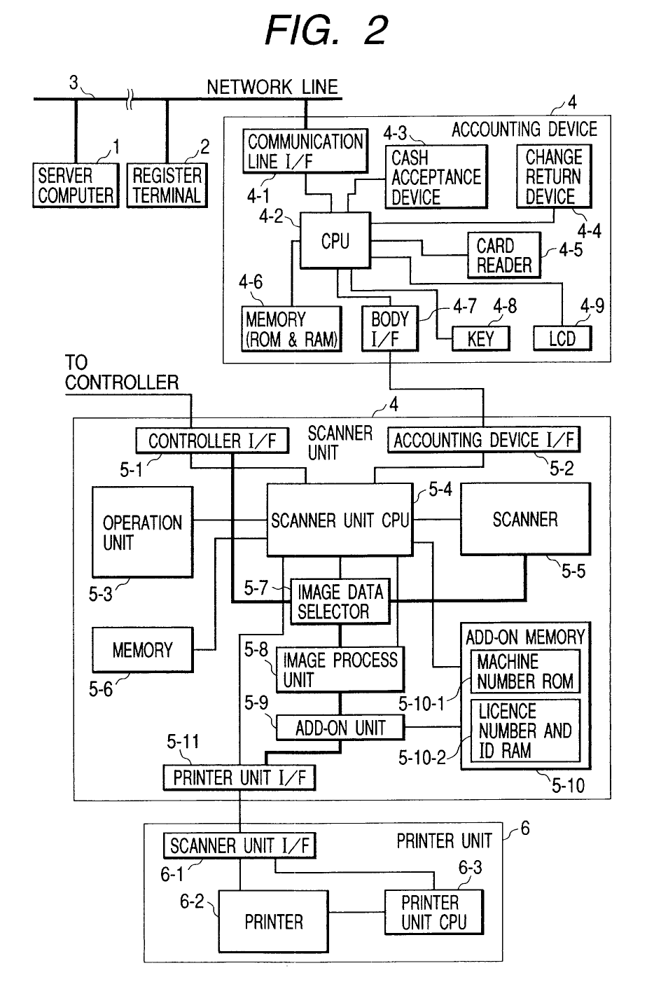

Referring to FIG. 1, the full color copying machine 201 is composed of a scanner unit 205 and a printer unit 206. The scanner unit 205 is controlled by an internal scanner CPU 5-4 (cf. FIG. 2), while the printer unit 206 is controlled by another internal printer CPU 6-3 (cf. FIG. 2).

The two CPU's exchange control commands and control data by mutual communication utilizing communication means such as a dual-port RAM (DRAM). The CPU 5-4 of the scanner unit 205 constitutes a master while the CPU 6-3 of the printer unit 206 constitutes a slave, whereby the printer unit 206 executes start of drum rotation, sheet feeding, printing operation etc. according to the instruction of the CPU 5-4 of the scanner unit 205.

The scanner unit 205 is provided with an operation unit 207 for controlling the copying operation, an original table 208 consisting of a transparent glass plate, a pressure plate 209 for pressing an original placed on the original table 208, an unrepresented original table sensor provided under the original table glass for detecting whether an original is placed thereon, an unrepresented photoelectric conversion device provided also under the original table glass and composed for example of a CCD, for reading the image of the original placed on the original table, and an image reading mechanism (scanner) composed of a motor etc.

In case of a copying operation, the user places an original on the original table 208, and depresses a copy button of the operation unit 207, whereby the image reading mechanism, through communication with the printer CPU and under the control by the scanner CPU, executes an image reading operation at a timing enabling printing, for example in synchronization with the rotation of a drum in an electrophotographic printer, and at the same time outputs the read image data to the printer unit 206 through video I/F's (printer I/F 5-11 and scanner I/F 6-1 shown in FIG. 2) between the printer unit and the scanner unit.

FIG. 2 is a block diagram showing an example of an image processing system in which the image processing apparatus of the first embodiment is applicable, corresponding to a system including the image processing apparatus shown in FIG. 1 and peripheral devices thereof.

Referring to FIG. 2, a server computer 1 is capable of communication with a register terminal 2 and an accounting device 4 through a network line 3. Also the accounting device 4 is capable of communication with a scanner unit 5 through a main body I/F 4-7.

The accounting device 4 is provided with a communication line I/F 4-1 capable of communication with the network line 3 by a predetermined protocol, a CPU 4-2 for executing a control program stored in a memory 4-6 composed of a ROM and RAM thereby controlling an accounting process and a communication process with the image processing apparatus etc., and a card reader 4-5 capable of reading different card media.

There are also provided a cash acceptance device 4-3 for receiving cash to be paid as the fee for the image processing by the user of the image processing apparatus, a change return device 4-4 for returning, to the user, a change resulting between the cash accepted by the cash acceptance device 4-3 and the fee for the image processing apparatus, a key 4-8 and an LCD display unit 4-9.

The scanner unit 5 is provided with a controller I/F 5-1, an accounting device I/F 5-2 for controlling the communication with the accounting device 4 through a main body I/F 4-7, an operation unit 5-3 for setting image processing conditions etc. desired by the user, a scanner CPU 5-4 for executing a control program stored in a memory unit 5-6 thereby controlling the scanning operation of a scanner 5-5, the communication with the printer unit 6 and with the accounting device 4.

There are also provided an image data selector 5-7 for switching the transfer of the image data read by the scanner 5-5 either to an image processing unit 5-8 or the controller I/F 5-1, and an add-on unit 5-9 for adding add-on information stored in an add-on memory 510 on the image data from the scanner 5-5 and transferring print data to the printer unit 6 through a printer I/F 5-11. The add-on memory 5-10 is provided with a machine number ROM 5-10-1 and a RAM 5-10-2 storing a license number and an ID.

The printer unit 6 is provided with a scanner I/F 6-1 for receiving the print data from the scanner unit 5 and transmitting a status etc. generated in a printer 6-2 to the scanner unit 5, and a printer CPU 6-3 for controlling the printing process of the print data based on a control program stored in an unrepresented memory.

In the image processing apparatus of the above-described configuration, the scanner unit 5 is controlled by the scanner CPU 5-4, to which connected are the scanner, I/F's, operation unit 5-3, memory 5-6 etc. Either the image data from the controller I/F 5-1 or those from the scanner 5 are selected by the image data selector 5-7 and are supplied to the image processing unit 5-8 in synchronization with an image head signal transferred from the printer unit 6. The image processing unit 5-8 is composed of hardware circuits such as a gate array, executes hardware image processing based on parameters set by the scanner CPU 5-4, and outputs the processed image data.

The scanner unit 5 is also provided with an add-on memory 5-10 incorporating a machine number ROM 5-10-1 storing a machine number for identifying the group of the color copying machines, and a RAM 5-10-2 for storing a license of the accounting device, a license number or a registered ID number read by a registration card reader. The machine number in the machine number ROM 5-10-1 and these ID information in the RAM 5-10-2 are read by the add-on unit 5-9 for conversion into a bit pattern, which is added to the image data from the image processing unit 5-9 and outputted to the printer unit 6.

The bit pattern obtained by such add-on process is constituted by a single yellow (Y) color of a low level, and is repeatedly positioned over the entire image area. Thus, on the entire printed image, the add-on bit pattern is superposed in a pale yellow pattern which is barely recognizable by the human eyes in the printed state.

The add-on process is not limited to the foregoing method but can also be achieved by other methods.

It is however possible to easily extract the original add-on bit pattern by reading the printed image with the add-on pattern by another scanner including a scanner unit 5 to extract the yellow plane only and executing image processing such as elevating the density level. By analyzing such bit pattern, it is possible to know the recorded machine number and the license number or the registration card ID, thereby specifying the user having executed the illegal image processing and the machine type used therefor.

Also the accounting device 220 shown in FIG. 1 is provided, as shown in FIG. 2, with a cash acceptance device 4-3 and a change returning device 4-4. The cash acceptance device 4-3 is provided with a slot for receiving a coin or a banknote, counts the cash thrown in and informs the CPU 4-2 of the amount of the cash. The change returning device 4-4 is provided with a coin tank and returns, in a return slot, an amount designated by the CPU 4-2.

The accounting device 220 is further provided with a communication line I/F 4-1 for information exchange with the exterior and is thus capable of communication for example with the server computer 1 through the network line 3.

It is further provided with a key 4-8 and an LCD 4-9 for interfacing with the user and with an I/F 4-7 for interfacing with the main body. These components are connected to and controlled by the CPU 4-2. The CPU 4-2 is connected with a memory 4-6 including a ROM and a RAM used for storing control data and for a work area.

The I/F 4-7 to the main body of the accounting device 220 is connected to an accounting control connector of the accounting I/F 5-2. The accounting control connector is principally composed of five signal lines, namely CRDY, PRDY, PSTB and serial signal lines RxD, TxD. The three signal lines CRDY, PRDY, PSTB are rendered active at the low level state, and the accounting device and the copying machine are both so constructed as to show a high impedance when the connector is not connected. The signal line CRDY is for a signal from the accounting device to the copying machine, and the signal lines PRDY, PSTB are for signals from the copying machine to the accounting device.

In the scanner unit of the copying machine 201, an internal program is provided with an unrepresented task for managing the accounting device. When the printing operation is not in progress, the copying machine 201 waits in a stand-by state in which the unnecessary power supply is cut off, and, in such state, the accounting device management task maintains the PSTB signal at the low-level active state.

Also in this state, the PRDY signal is maintained in a high-level inactive state. Also the accounting device management task maintains the printer in an activation inhibited state, so that any other task cannot activate the printer for printing. Thus, any printing operation cannot be started even by the depression of the copy key or by the transfer of PDL data from the host computer, and there is only allowed the display of a message that the printer is in preparation to the user.

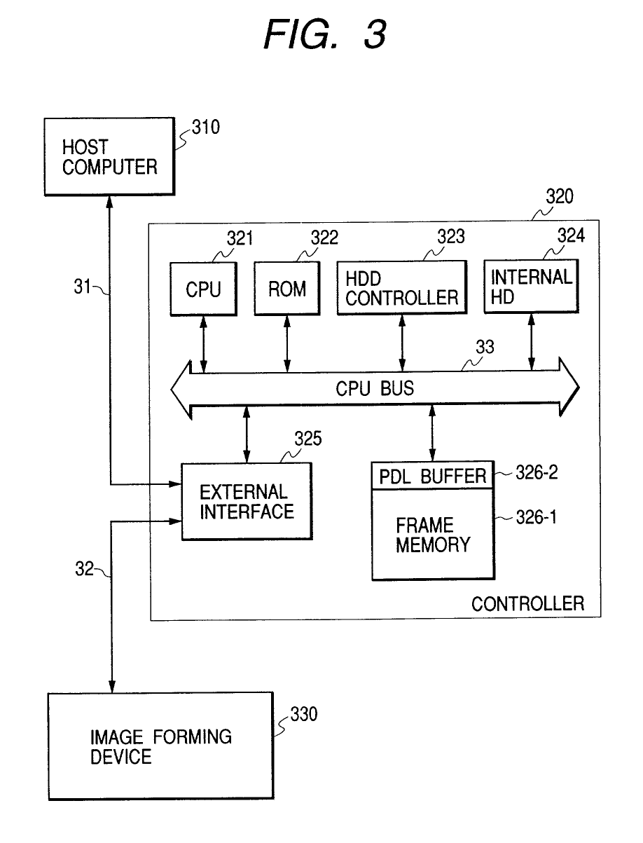

FIG. 3 is a block diagram schematically showing the configuration of the controller 202 shown in FIG. 1.

For example, in executing a printing operation, the host computer 310 becomes the source of supply of the print data (job). The job supplied from the host computer 310 is usually described in the format of a page description language (PDL) such as postscript, and there are also designated the paper feeding stage and the printing mode such as the color mode.

In case the full color copying machine 201 is installed for example in a convenience store, the host computer 310 is also installed in the same location. The user can print an image by sending an image to be printed in advance for example from a computer at home through a telephone line or a computer network, and by entering a predetermined password in the host computer 310.

It is also possible to bring a portable information terminal or a digital camera to the above-mentioned location for connection with the host computer 310 thereby transferring the print data, and cause the host computer to execute printing.

A controller 320 stores the print data, supplied from the host computer 310 through an interface cable 31 and an external interface 325, temporarily in an internal HD 324 through an HDD controller 323. A CCPU 321 controls various parts by executing control programs stored in a ROM 322 and the internal HD 324.

The print data held in the internal HD 324 are temporarily stored in a PDL buffer 326-2 on an internal RAM, through a CPU bus 33. The controller 320 develops the PDL data held in the buffer 326-2 on a frame memory 326-1 thereby generating image data. In this operation, there are generated full-color image data or gray-scale image data according to the PDL data.

The image data developed in the frame memory 326-1 are transferred to the image forming apparatus 330 through the cable 32 and the information required at the printing such as the paper feeding stage and the printing mode and described in the PDL data is supplied in advance as a command to the image forming apparatus 330 also through the cable 32.

In the image forming apparatus 330 of the present invention, the job management is executed by the scanner CPU 5-4 shown in FIG. 2, so that the command such as the print information or the print start command is also supplied to the scanner CPU 5-4.

Then, as in the case of copying operation, the scanner unit 5 sends a print start command to the printer unit 6 to receive a timing allowed for printing, and transmits the developed image data, page by page, to the printer unit 6 through the cable 32 in synchronization with such timing.

The cables 31, 32 are composed of ordinary cables such as parallel cables, SCSI cables, serial cables, network cables or a combination thereof, or exclusive cables.

The printer unit 206 shown in FIG. 1 sets a designated color operation mode etc. and executes the printing operation, utilizing the transmitted job information and image data signal.

There is executed a MCYK printing operation in case the image data signal is of full color, and a K (single color) printing operation in case the image data signal is of a gray scale. A sheet is supplied from a sheet cassette 210 of the designated sheet feeding stage or from a manual insertion slot 211, and the image is formed by an unrepresented image forming mechanism for example of electrophotographic or ink jet system on the sheet conveyed by a conveying mechanism to the image forming mechanism, whereupon the obtained print is discharged to an discharge aperture 212.

The resolution of the printed image may be equal to that of the image data signal supplied from the controller 202, for example 400 dpi, may be effectively doubled to 800 dpi by an interpolation process by a function of the image forming apparatus. It is naturally possible also to execute the printing for example with a half resolution of 200 dpi, depending on the printing ability of the image forming apparatus.

The printer unit 205 shown in FIG. 1 is also provided with an unrepresented two-side printing mechanism. In a job for which the two-side printing is designated, the scanner CPU 5-4 shown in FIG. 2 designates the sheet discharge to an internal two-side tray instead of the sheet discharge to the outside of the apparatus in the printing of the first surface (bottom surface). In the succeeding printing of the second surface (top surface), the two-side tray is designated as the source of sheet feeding, and the sheet is discharged to the outside of the apparatus after the printing of the second surface.

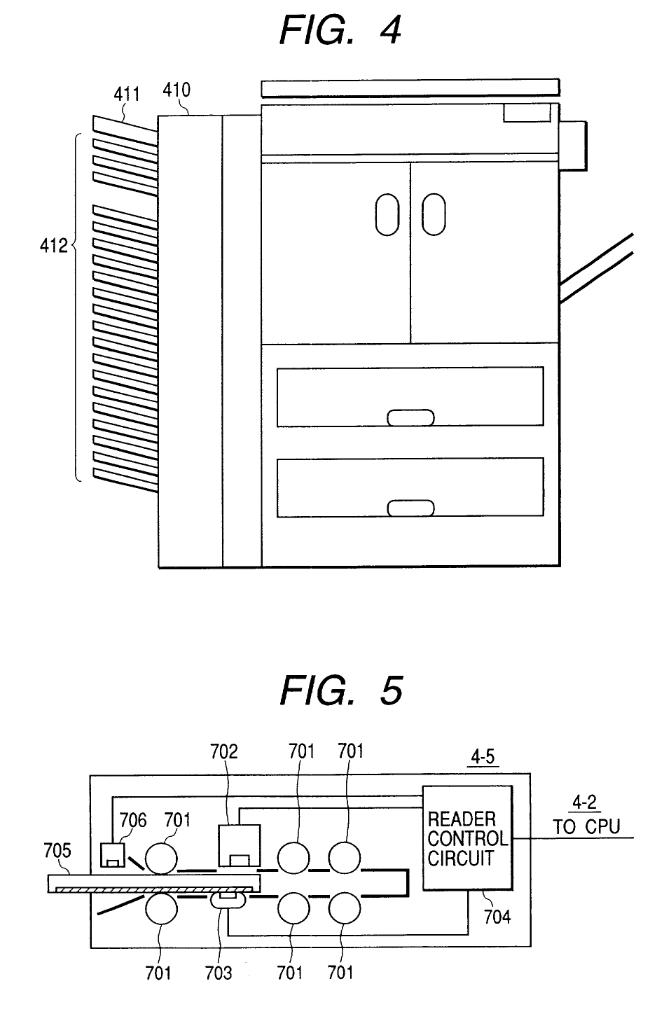

In the following there will be explained the configuration of an optional device shown in FIG. 4.

FIG. 4 shows an example of a sorter device optionally connectable to the image processing apparatus shown in FIG. 1. The image processing apparatus shown in FIG. 1 may be provided, opposed to the discharge slot 212 of the printer unit, with a stapling sorter (STS) 410 shown in FIG. 4 as a finisher.

The STS 410 is provided with a non-sort bin 411 at the top for discharging the output sheets in a non-sort operation, and note bins 412, in a job for which plural copies are designated, for discharging the output sheets by each copy or by each page in a note or group operation.

The non-sort bin 411 and the sort bins 412 are integrally moved vertically, and the bin for sheet discharge is determined by the vertical position. For example, FIG. 4 shows a state where a fourth bin from the top of the sort bins 412 is opposed to the discharge slot, and the output sheet in such state is discharged into such fourth bin.

In case there are designated plural copies each containing plural pages, the printing operation is usually executed continuously for the number of copies for each page. Thus, in case of a sorting operation, the sheets of a page 1 are discharged starting from the first bin, with successive downward movement of the discharging bin for each sheet (bin shift), and the bins are stopped once when the sheets of the designated number are discharged. Then, after the first sheet of a page 2 is discharged, the bins are moved in the opposite direction. Thereafter the moving direction of the bins is inverted at the first sheet of each page, whereby obtaining a sorted output containing all pages, with a sheet for each page, in each of the bins.

Also in case of a group operation, the sheet discharge is started from the first bin, and the bin is shifted downward after the discharge of sheets of the designated number of copies. In this manner there is obtained a grouped output in which each bin contains the sheets of a same page by the designated number of copies. Since the STS 410 has 20 bins, it is possible to designate up to 20 copies in case of the sorting operation, or up to 20 pages in case of the group operation.

The sort operation or the group operation is naturally possible also in the two-side printing mode, and, in such case, the above-mentioned bin shift is executed only after the printing of the second surface, namely when the sheet is discharged to the outside of the apparatus. For the two-side group operation, it is naturally possible to designate up to 40 pages.

The STS 410 is also provided with a stapling function. The stapling position can be designated at (a) corner, (b) double or (c) single, and such stapling position can be suitably selected according to the sheet size or the direction of the sheet.

These finishing operations, such as the two-side printing or the sorting, are executed by commands from the scanner CPU 5-4, which sends the image data to the printer unit 206 according to the designated operation.

The PDL data from the host computer 310 shown in FIG. 3 may contain the designation of such finishing operation, which is transmitted as commands from the controller 320 in FIG. 3 to the scanner CPU 5-4 in FIG. 2 through the cable 32 to execute the desired finishing operation not only in the copying operation but also in the printing operation.

The controller 320 may also acquire status information of the image forming apparatus 330, such as the sheet size, presence or absence of media or sheet, error or jam information in each sheet feeding stage, and inform the host computer 310 of such status information. Furthermore, such status information may be utilized for executing desired control on the image forming apparatus 330.

In case plural PDL data are sent in succession from the host computer prior to the completion of printing of a PDL data in the controller 320, such PDL data are cued in succession in the internal HD 324, and, at the completion of each image data development in the frame memory 326-1, a next PDL data is transferred in succession to the PDL buffer 326-2.

Since the image data developed in the frame memory 326-1 is not discarded until the completion of the printing, the image data development is started according to the progress of the printing operation and when an area is available in the frame buffer.

Also in case plural sorting or group jobs are instructed in succession, a message is usually displayed in an LCD panel on the operation unit 5-3 after the completion of a preceding printing operation, thereby causing the user to remove the sheets from the sort bins 412, and the printing of the next PDL data is started after the sheet absent status is established in the sort bins 412.

The CPU 321 functions according to the control program stored in the ROM 322, and controls the function of the controller 320. The internal HD 324 contains an area for temporarily storing the PDL data after printing or the image data generated by developing the PDL data, and an area for storing the font data, and is connected to the CPU bus 32 through the HDD controller 323. The internal HD 324 may also be so constructed as to function as an electronic sorter.

The RAM 326 includes the PDL buffer 326-2 for temporarily storing the PDL data received from the host computer 310, the frame memory 326-1 for developing the PDL data and temporarily storing thus developed image data, and other work areas required in the control program.

The ROM 322 may also be effectively constituted by a programmable memory (such as EEPROM) in which the control program is installed for example by the host computer 310, by a memory medium such as a floppy disk or a CD-ROM and a driver therefor.

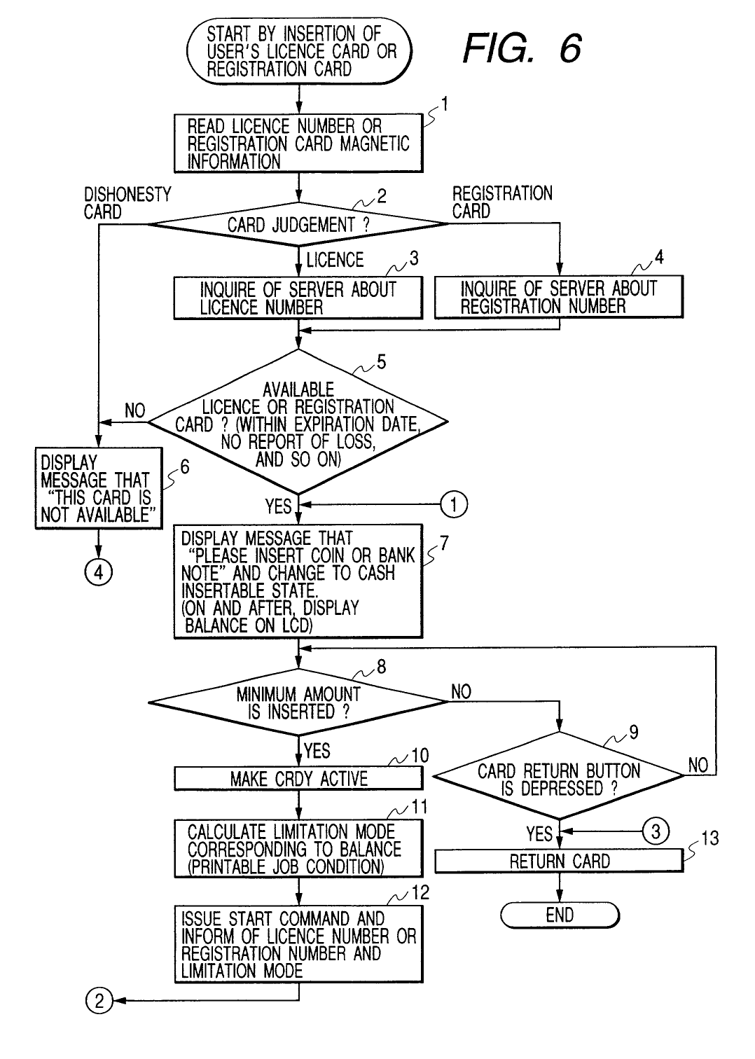

FIG. 5 is a view showing the configuration of a card reader 4-5 shown in FIG. 2, wherein components same as those in FIG. 1 are represented by same numbers.

Referring to FIG. 5, when a card medium (card) 705 such as a license card is inserted in the card reader 4-5, a sensor 706 detects the insertion of the card whereby the card 705 is conveyed by plural conveying rollers 701 to the deep part of the card reader 4-5.

The card reader 4-5 is provided with an optical line sensor 702 for reading the image on the surface of the card during the conveying thereof. The read image data are supplied to the CPU 4-2 of the accounting device 4 and are subjected therein to pattern matching, whereby the registration number of the license is read.

The card reader 4-5 may also be provided with a magnetic head 703, thereby reading the registration number recorded in a magnetic part on the bottom surface of a magnetic card registered for the user for example at a registration counter.

These functions of the card reader 4-5 are controlled by a reader control circuit 704 connected to the CPU 4-2, for driving unrepresented motor and drive circuit.

When the user sets a license in the card reader 4-5, the optical sensor reads the pattern on the surface of the license. On the license, the format of the print position of the number is determined in advance, and the license number can be easily extracted by pattern matching in the CPU 4-2 by storing the data of such format in the memory.

Naturally a card not matching the format cannot be accepted, and an error message is displayed on the LCD 4-9. The read license number is sent through the communication line to the server computer 1. The license number reported as stolen or lost is registered in advance in the server computer 1, and, if such license number is matched, a notice is given to the registration terminal 2 through the communication line.

If it is confirmed that the license has not been reported as stolen or lost, the accounting device 220 displays a message requesting deposit of cash, on the LCD 4-9. When the cash acceptance device 4-3 detects the cash deposit, the CPU 4-2 of the accounting device 220 issues a command to the main body through the main body I/F 4-7 for shifting to the print enabled state.

On the other hand, if a user without the license wishes to execute copying or printing, the user presents another ID to the shop clerk of the registration counter, thus having the clerk to prepare a registration card. Such card is provided on the bottom surface with a magnetic stripe, storing a registration number.

When the user sets the registration card in the card reader 4-5, the magnetic head 703 reads the registration number recorded on the card. The read registration number is sent through the communication line for a reference check for any expiration or reported loss of the card at the server computer 1 in which all the registration numbers are stored.

If the set registration card is identified as properly usable, the accounting device 220 requests, as in the case of the license, the deposit of the cash to the user, and, when the cash deposit is detected, sends a command to the main body through the main body I/F 47 for shifting to the print enabled state.

The fees for color, B/W and different sizes per sheet are stored in advance in the memory 4-6 of the accounting device 220. The remainder of the deposited cash amount is memorized in the memory 4-6 of the accounting device 220 and is displayed on the LCD 4-9 thereof.

The level of the print enabled state is determined according to such remainder. For example, there is calculated limitation information that the printing is enabled only for a certain or smaller size or for a B/W print, if the remainder is low.

In the ordinary waiting state, the CRDY signal of the accounting device I/F is informed as the high level or inactive state to the main body scanner unit 5. Upon detecting a cash deposit exceeding a predetermined amount, the accounting device 220 switches the CRDY signal to the active (low level) state, and informs the copying machine 201 of the start command and the limitation information through the signal line RxD. In the start command there is also informed the license number or the registration number.

The accounting device management task does not shift to the printer start enabled state unless the CRDY signal is rendered active. When the accounting device is detached, the CRDY signal is in an open state, namely in the inactive state, so that the printer cannot be activated.

Receiving the start command from the signal line RxD, the accounting device management task memorizes the license number or the registration number, transmitted with the command, in an add-on memory. Then it shifts the PRDY signal to the active state and the PSTB signal to the inactive state, thereby shifting from the standby state to the print enabled state.

In this operation, according to the limitation information transmitted together with the start command, there can be assumed a limitation print enabled state in which the printing is permitted only for the B/W print or the print not exceeding a certain size. Thereafter an acknowledgement signal Ack to the start command is sent to the accounting device through the signal line TxD.

Thus, the accounting device 220 can know proper connection of the image forming apparatus from a fact that either one of the PRDY and PSTB signals is always active. If the signals are both in the high-level inactive state, the image forming apparatus is not connected, so that the accounting device can execute such control as not to accept any license, card or cash.

Also in case the image forming apparatus 201 is incapable of shifting to the print enabled state upon receipt of the start command, because of an error in the main body, a signal NACK is returned to the accounting device in response to the start command. In such case an error message is displayed on the operation unit of the main body.

Upon released from the standby state and shifting to the print enabled state, the color image forming apparatus 201 can now accept a print start command from the copy start button or the controller, thus being rendered capable of printing and copying.

At the printing, the add-on unit 5-9 records the machine number stored in the add-on memory 5-10 and the card ID and user ID of the user on the sheet, and such record can be utilized later for specifying the user who executed the printing.

During the printing, the scanner CPU 5-4 issues a print information command including sheet size and information on the color or B/W mode for each print, upon detection of completion of each print from the printer, for supply to the accounting device 220 through the accounting device I/F 5-2.

The accounting device 220 calculates the fee based on the received information, and subtracts the calculated fee from the remainder. If the remainder becomes short of a predetermined amount, it recalculates the limitation information and reissues the start command to inform the color image forming apparatus of the limitation information, thereby shifting the apparatus to the limitation print enabled state.

In such limitation print enabled state, if the user wishes to execute the printing with a setting outside such limitation, a message informing such limitation is displayed on the LCD of the operation unit in response to the reception of the print command from the controller or to the depression of the start button in the operation unit of the main body, whereby the user can know that the cash remainder is deficient.

A start command is issued at each change of the limitation condition by the additional deposit of cash by the user in the cash acceptance device 4-3, and image forming apparatus shifts to a print enabled state matching the limitation condition transmitted from time to time.

Having completed the printing or copying operation, the user depresses a card return button of the accounting device 220. Detecting the depression of the card return button, the CPU 4-2 of the accounting device at first causes the card reader 4-5 to return the license or the registration card set therein.

Then it returns the CRDY signal, to the main body through the I/F 4-7, to the high-level inactive state and issues an end command to the main body. It then causes the change return device to return the cash corresponding to the remainder.

Upon detecting the inactive state of the CRDY signal and the end command from the signal line RxD, the accounting device management task of the program of the scanner CPU 5-4 shifts the PRDY signal to the inactive state and the PSTB signal to the active state.

Then it shifts to the standby state, thereby inhibiting the printing operation, and also clears the license number or the registration number memorized in the add-on memory 5-10.

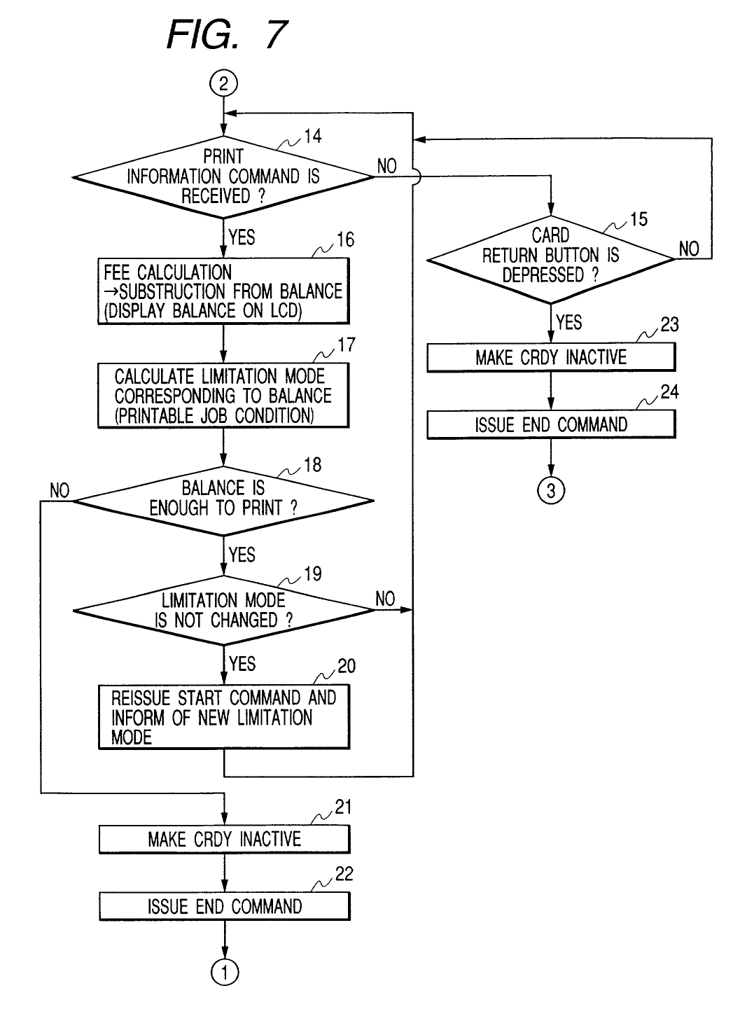

FIG. 6 shows the process sequence in the accounting device, and FIG. 7 shows the process sequence of the accounting device management task in the scanner CPU.

FIGS. 6 and 7 are flow charts showing an example of a first data processing procedure in the image processing apparatus of the present invention, and corresponding to the process sequence in the accounting device 220, wherein numerals 1 to 24 indicate process steps.

At first, in a step 1, when a card medium (card) 705 such as a license is inserted into the card reader, the sensor 706 detects the insertion whereby the card 705 is conveyed by the plural conveying rollers 701 to the deep part of the card reader 4-5.

The card reader 405, being provided with the optical line sensor 702, reads the image on the surface of the card while it is conveyed, and the read image data are supplied to the CPU 4-2 of the accounting device 4 for pattern matching whereby the registration number of the license is read.

Also the card reader 4-5 may be provided with the magnetic head 703 for reading the registration number recorded on the magnetic member on the bottom surface of the magnetic card, for the user who is registered in advance for example at the registration counter.

Then a step 2 judges the card, and, if an improper card other than the license or the registration card, the sequence proceeds to a step 6 for displaying a message such as “This card is not usable” on the LCD 4-9. Then a step 13 returns the inserted card and the sequence is terminated.

On the other hand, if the step 2 identifies that the read card is a license, a step 3 inquires the read license number to the server computer 1. Then a step 5 judges, from the response, if it is a usable license, and if not, the sequence proceeds to a step 6, but, if usable, a step 7 display a message “Deposit banknote or coin” on the LCD 4-9.

Then a step 8 judges whether the deposited amount is at least equal to a minimum among, and, if judged not by the CPU 4-2, it judges in a step 9 whether the card return button in the key 408 is depressed, and, if not depressed, the sequence returns to the step 8.

On the other hand, if the step 8 judges that the deposited cash it at least equal to the minimum amount, the CPU 4-2 of the accounting device 220 sends, through the I/F 4-7 to the main body, the command for shifting to the print enabled state (shifting the CRDY signal to the active state) (step 10).

Then a step 11 calculates the remainder of the deposited amount, and a step 12 informs, by the serial signal line RxD, the copying machine 201 of the limitation information together with the start command, which is also associated with the license number or the registration number. The accounting device management task does not shift to the print enabled state unless the CRDY signal is made active. If the accounting device is detached, the CRDY signal is maintained in the open or inactive state, so that the printer cannot be activated.

Then, in a step 14, the color image forming apparatus 201 that have left the standby state and have shifted to the print enabled state judges whether the print start from the copy start button or the controller has been accepted, and, if not, there is judged whether the card return button has been depressed (step 15). If the card return button is judged to have been depressed, a step 23 shifts the CRDY signal to an open or inactive state, and a step 24 issues the end command, whereupon the sequence proceeds to a step 13.

On the other hand, if the step 14 identifies that the print start has been accepted, a step 16 executes for calculation and subtracts the fee from the remainder, thereby renewing the remainder specific to the user. Then a step 18 judges whether the remainder is enough for printing, then, if not, a step 21 shifts CRDY signal to the open or inactive state and a step 22 issues the end command, whereupon the sequence proceeds to the step 7.

On the other hand, if the step 18 judges that the remainder is enough for printing, a step 19 judges whether the limitation mode has been changed, and, if changed, the sequence returns to the step 14, but, if not changed, a step 20 reissues the start command and informs the new limitation mode, whereupon the sequence returns to the step 14.

On the other hand, if the step 2 judges the card as a registration card, a step 4 inquires to the server computer 1 if the card is usable, and the sequence proceeds to a step 5.

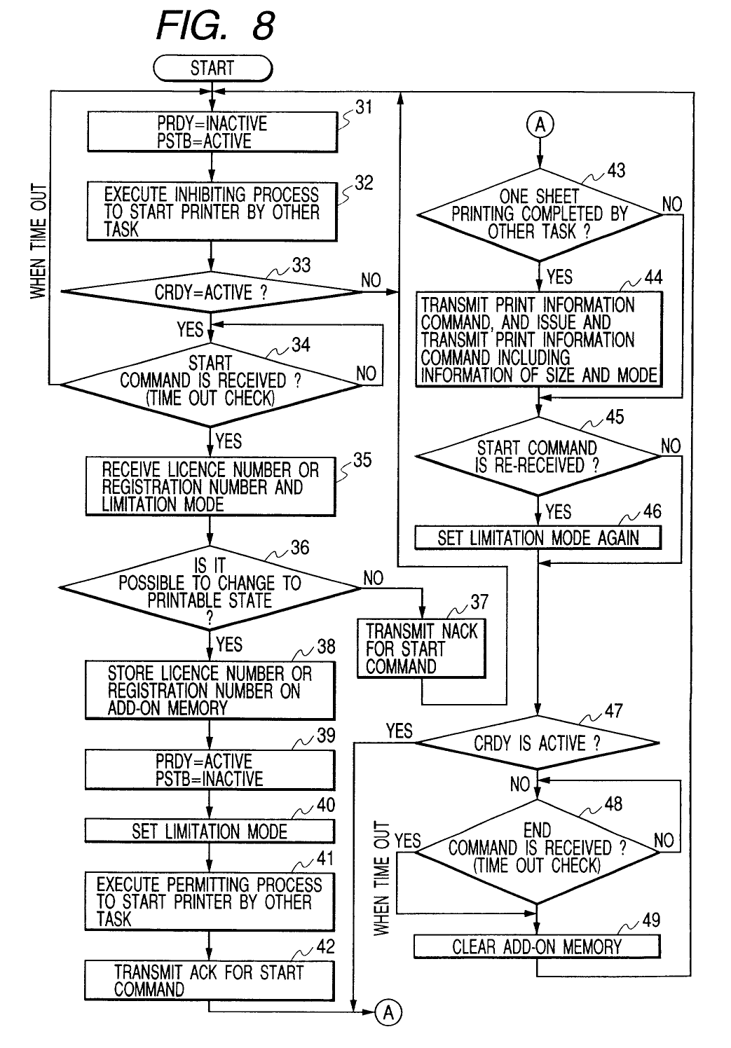

FIG. 8 is a flow chart showing an example of a second data processing procedure in the image processing apparatus of the first embodiment, corresponding to the process sequence of the accounting device management task in the scanner CPU 5-4 shown in FIG. 2, wherein numerals 31 to 49 indicate process steps.

At first the accounting device management task memorizes, upon receiving the start command from the signal line RxD, the license number or the registration number transmitted therewith in the add-on memory. Then a step 31 shifts the PRDY signal to the active state and the PSTB signal to the inactive state, thereby leaving the standby state and shifting to print enabled state.

Then a step 32 executes a process of inhibiting the activation of the printer from other tasks, then a step 33 judges whether the CCRDY signal of the accounting device interface 5-2 is active, and, if not, namely if inactive, the sequence returns to the step 31.

On the other hand, if the step 33 identifies the active state, a step 34 judges whether the start command is received within a predetermined time, and if not received, the step 34 is repeated, and, if the time expires, the sequence returns to the step 31.

On the other hand, if the step 34 identifies the reception of the start command, a step 35 receives the license number or the registration number and the limitation mode.

Then a step 36 judges whether the shift to the print enabled state is possible, and, if not, the sequence proceeds to a step 37 for transmitting the NACK signal in response to the start command, whereupon the sequence returns to the step 31.

On the other hand, if the step 36 identifies the print enabled state, a step 38 memorizes the license number of the registration number in the add-on memory 5-10.

Then a step 39 shifts the PRDY signal to the active state and the PSTB signal to the inactive state. Then a step 40 sets the limitation mode, and a step 41 executes a process of permitting the printer activation from another task, for example setting the limitation print enabled state permitting the B/W print only or the print under a certain size according to the limitation information transmitted together with the start command.

Then a step 42 transmits the ACK signal in response to the start command, and a step 43 judges whether a print is completed from another task. If not completed, the sequence proceeds to a step 45, but, if completed, the sequence proceeds to a step 44 to issue the print information command including the sheet size and the information indicating the B/W mode or the color mode to the accounting device 220 through the accounting device I/F 5-2.

Then, in a step 45, the color image forming apparatus 201 which has left the standby state and has shifted to the print enabled state judges whether the copy start has been received again from the copy start button or from the controller, and, if not received, the sequence proceeds to a step 47. If received, the accounting device 220 calculates the fee based on the received information, and subtracts the predetermined amount from the remainder. If the remainder becomes less than the predetermined amount, the limitation information is calculated again, and the start command according to the limitation mode is reissued to inform the color image forming apparatus of the limitation information, whereby the apparatus is shifted to the limitation print enabled state.

Then a step 47 judges whether the CRDY signal to the main body I/F 4-7 is still in the active state, and, if still in the active state, the sequence returns to the step 43, but, if not in the active state, the sequence proceeds to a step 48 which, upon detecting the inactive state of the CRDY signal and the end command from the signal line RxD, shifts the PRDY signal to the inactive state and the PSTB signal to the active state.

Then a step 49 executes shift to the standby state thereby inhibiting the printing operation and clears the license number or the registration number stored in the add-on memory 5-10, whereupon the sequence returns to the step 31.

In case the power supply of the copying machine is turned off or the connector cable of the accounting device is detached before the card is returned, the PRDY signal is suddenly shifted to the inactive state while the PSTB signal remains in the inactive state. In such case, the accounting device 220 promptly shifts the CRDY signal to the inactive state and returns the remainder. Also an alarm is given in a predetermined location, such as the registration counter of the convenience store.

The power supply of the accounting device 220 is separate from that of the main body, and cannot be turned off within the reach of the user. The accounting device 220 is also provided with a backup power supply and can continue functioning for a short time even if the power supply is broken down.

However, if the power supply of the accounting device 220 alone is cut off while the color image forming apparatus remains in the print enabled state, the scanner CPU 5-4 gives an alarm sound in the operation unit. The detection of such state is achieved by the CRDY signal, and, if the end command is not transmitted after the CRDY signal is shifted to the inactive state, there is executed the process of generating the alarm sound, and all the printing operations are inhibited thereafter.

According to the first embodiment explained in the foregoing, an image processing apparatus, in which a server device and a manager terminal device are capable of communication through a predetermined communication medium and which is capable of controlling the execution of image processing by confirming the fee payment charged for a predetermined image processing, is adapted to limit the request for image processing by comparing the personal identification information read by a card reader and the image output limited personal information acquired from the server device, then, for a proper user, to convert the aforementioned personal identification information read by the card reader into the personal identification image data, and to generate the output image data from thus converted personal identification image data and the image data requested by the user for image processing, whereby it is rendered possible to construct an image processing environment capable of securely applying limitation by recognizing the request for the image processing by the improper user and properly executing the image processing requested by the proper user, thereby efficiently realizing the image processing service while maintaining a high level of security.

Also it is rendered possible to embed effective information in the image, since the license number or the magnetic card information to be embedded in the image is transmitted to the server computer for inquiring whether the ID information contained therein is effective.

[Second Embodiment]

In the first embodiment there has been explained an example of utilizing a license or a registration card as the card medium, but the second embodiment explains an example where a credit card is used as the card medium.

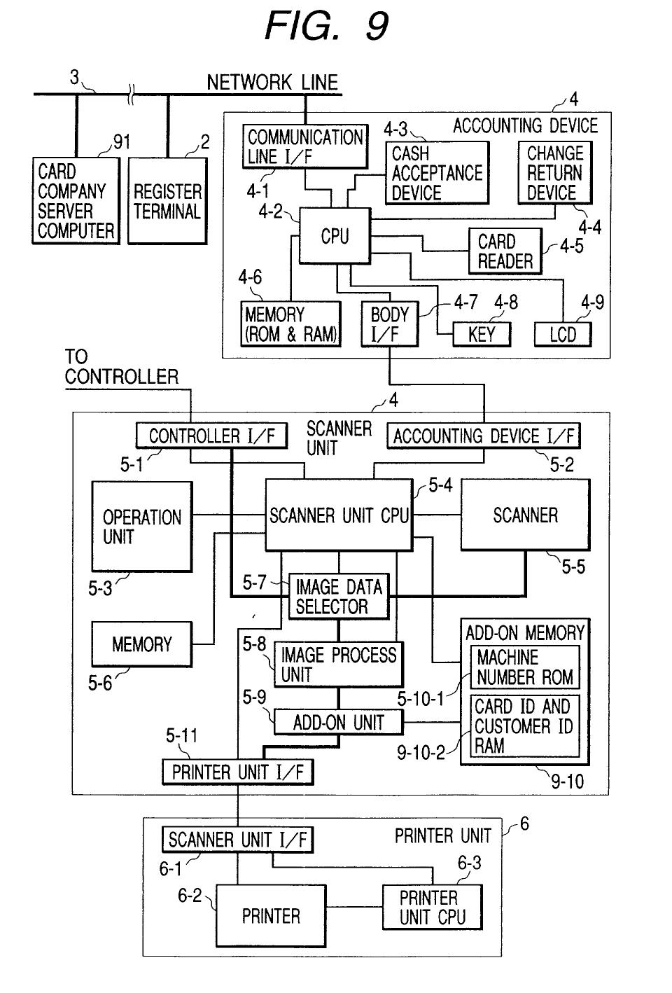

FIG. 9 is a block diagram showing an example of the image processing system in which an image processing apparatus of the second embodiment is applicable, and which corresponds to the system including the image processing apparatus and the peripheral devices as shown in FIG. 1. In FIG. 9, the server computer 1 and the license number & ID RAM shown in FIG. 2 are respectively replaced by a card company server computer 9 and a card ID & customer ID RAM 9-10-2, and the components same as those in FIG. 2 are represented by same numbers.

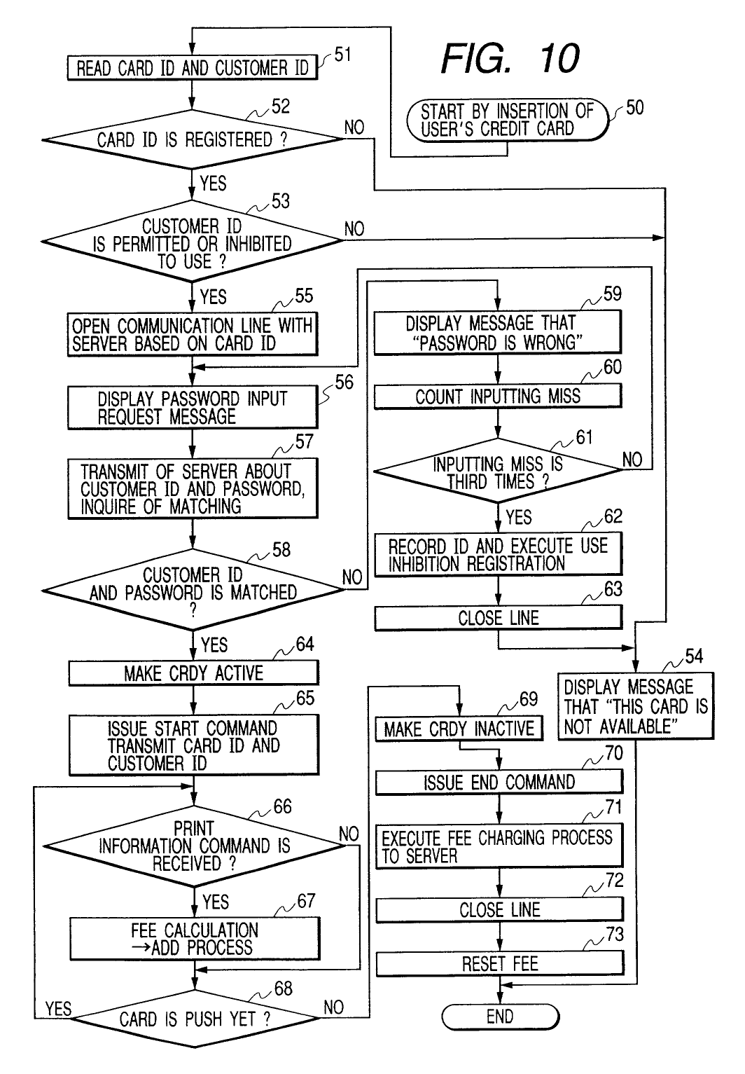

FIG. 10 is a flow chart showing an example of a first data processing sequence in the image processing apparatus of the second embodiment, corresponding to the process sequence in the accounting device 220. Numerals 50 to 73 indicate process steps.

At first, in a step 50, when a card medium (card) 705 such as a credit card is inserted into the card reader, the sensor 706 detects the insertion whereby the card 705 is conveyed by the plural conveying rollers 701 to the deep part of the card reader 4-5.

The card reader 4-5, being provided with the optical line sensor 702, reads the image on the surface of the card while it is conveyed in a step 51. The read magnetic information includes a card ID and a customer ID.

Then a step 52 judges whether the read card ID is registered. If the read card ID is not judged as registered, the sequence proceeds to a step 54 for displaying a message such as “This card is not usable” on the LCD 4-9, whereupon the sequence is terminated.

On the other hand, if the step 52 identifies that the read card ID is registered, a step 53 judges whether the customer ID is inhibited for use or registered. If the customer ID is not judged as registered, the sequence proceeds to a step 54 for displaying a message such as “This card is not usable” on the LCD 4-9, whereupon the sequence is terminated. The discriminations of the steps 52, 53 may also be executed in the inverted order.

If the steps 52, 53 identify that the card ID and the customer ID of the credit card are registered, the sequence proceeds to a step 55 for opening the network channel to the card company server computer through the communication line I/F.

A step 56 displays a message on the LCD 4-9, requesting the user to enter a password, which is entered by the key 4-8.

The read customer ID and the entered password are supplied to the card company server computer through the network channel, and a step 57 inquires whether the correct password is entered for the customer ID.

If a step 58 identifies that the password does not match the customer ID, a step 59 displays a message such as “Wrong password” on the LCD 4-9 to request the reentry of the password by the user, but a step 60 counts the number of entries of the wrong passwords. If a step 61 identifies that the wrong passwords are entered three times in succession, a step 62 records the customer ID in the memory and thereafter inhibits the use of the credit card of this customer ID. Then a step 62 closes the line to the card company server computer, and a step 54 displays a message such as “This card is not usable” on the LCD 4-9, whereupon the sequence is terminated.

On the other hand, if the step 58 identifies that the password matches the read customer ID, the CPU 4-2 of the accounting device 220 shifts the CRDY signal, to the main body through the main body I/F 4-7, to a low-level active state thereby commanding the shift to the print enabled state. Then a step 65 sends to the copying machine 201 through the signal line RxD, a card company ID number and the customer ID number together with the start command.

The accounting device management task does not shift to the print enabled state unless the CRDY signal is made active. If the accounting device is detached, the CRDY signal is maintained in the open or inactive state, so that the printer cannot be activated.

Then, in a step 66, the color image forming apparatus 201 that have left the standby state and have shifted to the print enabled state judges whether the print start from the copy button or the controller has been accepted.

If the judgment in the step 66 is YES, a step 67 receives a print information command and a step 68 calculates the fee based on the received print information command and adds the fee from the start.

When a step 68 detects that the card has been extracted from the card reader, the CPU of the accounting device in a step 59 returns the CRDY signal to the main body to the high-level inactive state, and issues the end command to the main body through the signal line RxD. Then a step 71 executes communication with the card company server computer through the communication line I/F thereby billing the fee charged from the start.

Otherwise, the accounting device may, instead of executing the fee calculation based on the received print information command, send the print information command to the card company server computer through the communication line I/F.

Then a step 72 closes the network channel to the card company, and a step 73 resets the fee, whereupon the sequence is terminated.

FIG. 10 is a flow chart showing an example of a second data processing sequence in the image processing apparatus of the second embodiment, corresponding to the process sequence of the accounting device management task in the scanner CPU 5-4 shown in FIG. 2. Numerals 74 to 91 indicate process steps.

At first the accounting device management task memorizes, upon receiving the start command from the signal line RxD, the card ID and the customer ID transmitted therewith in the add-on memory. Then a step 74 shifts the PRDY signal to the active state and the PSTB signal to the inactive state, thereby leaving the standby state and shifting to the print enabled state.

Then a step 75 executes a process of inhibiting the activation of the printer from other tasks, then a step 76 judges whether the CRDY signal of the accounting device interface 5-2 is active, and, if not, namely if inactive, the sequence returns to the step 74.

On the other hand, if the step 76 identifies the active state, a step 77 judges whether the start command is received within a predetermined time, and if not received, the step 77 is repeated, and, if the time expires, the sequence returns to the step 74.

On the other hand, if the step 77 identifies the reception of the start command, a step 78 receives the card ID and the customer ID, and also receives the limitation mode.

Then a step 79 judges whether the shift to the print enabled state is possible, and, if not, the sequence proceeds to a step 91 for transmitting the NACK signal in response to the start command, whereupon the sequence returns to the step 74.

On the other hand, if the step 79 identifies the print enabled state, a step 80 memorizes the card ID and the customer ID in the add-on memory 5-10.

Then a step 81 shifts the PRDY signal to the active state and the PSTB signal to the inactive state. Then a step 82 sets the limitation mode, and a step 83 executes a process of permitting the printer activation from another task, for example setting the limitation print enabled state permitting the B/W print only or the print under a certain size according to the limitation information transmitted together with the start command.

Then a step 84 transmits the ACK signal in response to the start command, and a step 85 judges whether a print is completed from another task. If not completed, the sequence proceeds to a step 87, but, if completed, the sequence proceeds to a step 86 to issue the print information command including the sheet size and the information indicating the B/W or color mode to the accounting device 220 through the accounting device I/F 5-2.

Then, in a step 87, the color image forming apparatus 201 which has left the standby state and has shifted to the print enabled state judges whether the copy start command has been received again from the copy start button or from the controller, and, if not received, the sequence proceeds to a step 89. If received, the accounting device 220 calculates the fee based on the received information and adds the fee from the start.

Then a step 89 judges whether the CRDY signal to the main body through the I/F 4-7 is still in the active state, and, if still in the active state, the sequence returns to the step 85, but, if not in the active state, the sequence proceeds to a step 90 which, upon detecting the inactive state of the CRDY signal and the end command from the signal line RxD, shifts the PRDY signal to the inactive state and the PSTB signal to the active state.

Then a step 91 executes shift to the standby state thereby inhibiting the printing operation and clears the card ID and the customer ID stored in the add-on memory 5-10, whereupon the sequence returns to the step 74.

In case the power supply of the copying machine is turned off or the connector cable of the accounting device is detached before the card is returned, the PRDY signal is suddenly shifted to the inactive state while the PSTB signal remains in the inactive state. In such case, the accounting device 220 promptly shifts the CRDY signal to the inactive state and executes the total billing. Also an alarm is given in a predetermined location, such as the registration counter of the convenience store.

The power supply of the accounting device 220 is separate from that of the main body, and cannot be turned off within the reach of the user. The accounting device 220 is also provided with a backup power supply and can continue functioning for a short time even if the power supply is broken down.

However, if the power supply of the accounting device 220 alone is cut off while the color image forming apparatus remains in the print enabled state, the scanner CPU 5-4 gives an alarm sound in the operation unit. The detection of such state is achieved by the CRDY signal, and, if the end command is not transmitted after the CRDY signal is shifted to the inactive state, there is executed the process of generating the alarm sound, and all the printing operations are inhibited thereafter.

In the foregoing embodiment, there has been explained an accounting device utilizing the credit card, but there may naturally be utilized an accounting device utilizing a debit card which is recently becoming popular. In such case the configuration is similar to that shown in FIG. 1, but the communication line I/F is connected the server of a bank in which the user has an account, and the ID memorized in the add-on memory is the bank ID, the branch ID and the account number. The printing and accounting operations are same as explained in the foregoing, and the fee is directly transferred from the account of the user to a predetermined account.

Also in the second embodiment, the accounting device reads the card company ID and the customer ID by the card reader, but the card company ID and the customer ID may be entered by the user through the numeral keys.

Thus, according to the second embodiment explained in the foregoing, in the color image forming apparatus used by unidentified plural users, it is rendered easier to facilitate specifying the person who executed the image formation, by adding the information on the addressee of fee billing, namely the ID information of the credit card, to the image at the image forming operation.

Also it is rendered possible to embed effective information in the image, since the card ID or the customer ID of the credit card to be embedded in the image is transmitted to the server computer for inquiring whether the ID information contained therein is effective.

[Other Embodiments]

In the foregoing first and second embodiments, the personal identification ID information such as the license or the credit card is always added to the formed image.

However, the ID information for specifying person such as the credit card is important information, and such adding of the ID information may not be preferred by certain users even though such information is added in a manner not easily recognizable to the human eyes.

Also the personal information such as the above-mentioned ID information may be extracted from the image including such ID information and may be used illegally.

It is therefore possible to provide the image forming apparatus with an identification device for identifying whether the input image is a specified image such as a banknote or a valuable paper, and to add the ID information only in case the input image is identified as a specified image by the identification device.

In this manner it is made possible to prevent the leakage of personal information and to prevent forging of the banknote or the valuable paper by suppressing the excessive addition of the personal information.

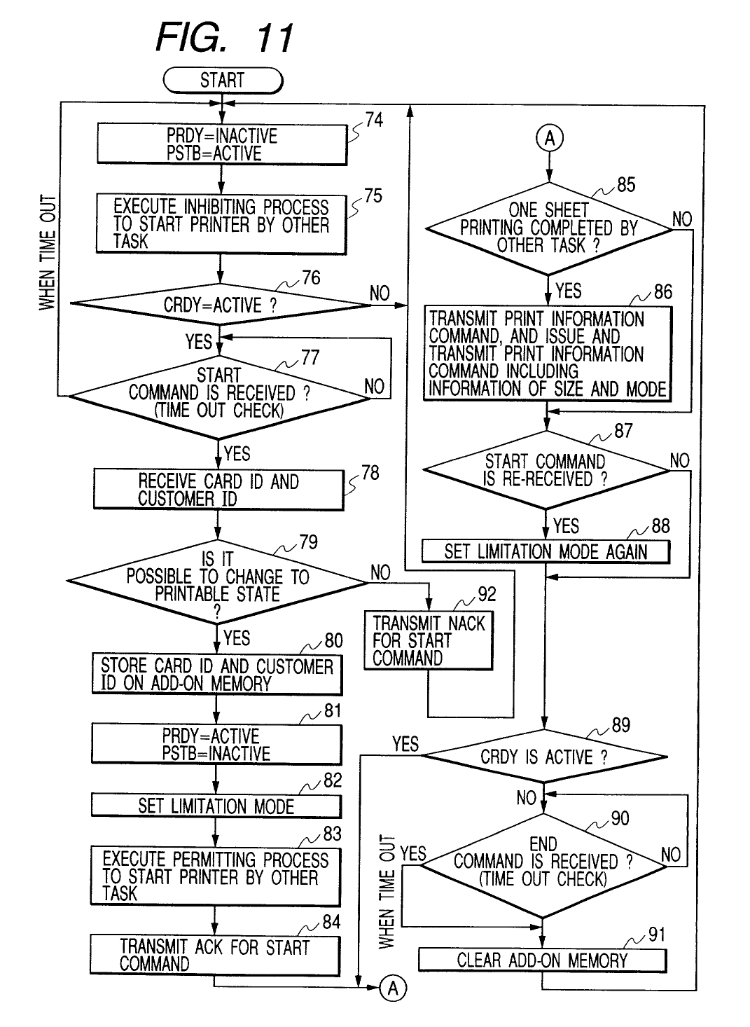

In the following there will be explained, with reference to a memory map shown in FIG. 11, the configuration of a data processing program readable by an image processing system in which the image processing apparatus of the present invention is applicable.

FIG. 11 is a view showing the memory map of a storage medium storing various data processing programs readable by the image processing system in which the image processing apparatus of the present invention is applicable.

Though not particularly illustrated, there may also be stored information for managing the programs stored in the storage medium, such as version information, author of the program etc., and information dependent on the operating system of the program reading side, such as an icon for identifying and indicating the program.

Also data belonging to various programs are managed by the above-mentioned directory. There may furthermore be stored a program for installing various programs into the computer, and a decompression program in case the program to be installed is compressed.

In the present embodiment, the functions shown in FIGS. 6, 7, 8, 10 and 11 may be executed by a host computer based on a program installed from the exterior. The present invention is applicable also in case the information including the programs is supplied to the output apparatus by a storage medium such as a CD-ROM, a flush memory or a FD, or through a network from an external storage medium.

The objects of the present invention can naturally be attained also in a case where a memory medium storing the program codes of a software realizing the functions of the aforementioned embodiments is supplied to a system or an apparatus and the functions of the aforementioned embodiments are realized by a computer (CPU or MPU) of the above-mentioned system or apparatus by reading and executing the program codes stored in the memory medium.

In such case the program codes themselves of the software realize the novel functions of the present invention, and the memory medium storing the program codes constitutes the present invention.

The memory medium storing such program codes can be, for example, a floppy disk, a hard disk, an optical disk, a magnetooptical disk, a CD-ROM, a CD-R, a magnetic tape, a non-volatile memory card, a ROM or an EEPROM.

The present invention also includes not only a case where the functions of the aforementioned embodiments are realized by the execution of the program codes read by the computer but also a case where an operating system or the like functioning on the computer executes all or a part of the actual processes under the control of such program codes thereby realizing the functions of the foregoing embodiments.

The present invention further includes a case wherein the program codes read from the memory medium are once stored in a function expansion board inserted into the computer or a function expansion unit connected to the computer, and a CPU provided in the function expansion board or the function expansion unit executes all the process or a part thereof under the control of such program codes, thereby realizing the functions of the aforementioned embodiments.

What is claimed is:

1. An image processing apparatus which is connected with an information communication apparatus, comprising:
first input means for entering information on an addressee of fee billing from said information communication apparatus;
second input means for entering an image;
addition means for adding said information on the addressee of fee billing to said image in a manner not easily recognizable to human eyes; and
output means for outputting said added image.

2. An image processing apparatus according to claim 1, further comprising second output means for outputting information based on the output of said outputted image to said information communication apparatus.

3. An image processing apparatus according to claim 1, wherein said information on the addressee of fee billing includes information for specifying a company issuing a credit card, and information for specifying a user of said credit card.

4. An image processing apparatus according to claim 1, wherein said information on the addressee of fee billing includes information for specifying a bank issuing a debit card, and information for specifying a user of said debit card.

5. An image processing apparatus according to claim 1, wherein said first input means further enters information for enabling activation of said image processing apparatus from said information communication apparatus, and said second input means starts the entry of said image after the entry of information for enabling activation of said image processing apparatus.

6. An image processing apparatus according to claim 1, wherein said information based on the output of image includes at least one of the information on the sheet size, color mode and black-and-white mode.

7. An image processing apparatus according to claim 1, further comprising discrimination means for discriminating whether said image is a specified image, and control means for controlling the addition by said addition means based on the result of discrimination by said discrimination means.

8. An image processing apparatus according to claim 1, wherein said addition means adds information specific to the apparatus.

9. An information communication apparatus which is connected with an image processing apparatus and capable of communicating with an external server, comprising:
first input means for entering information on an addressee of fee billing and a password;
first output means for outputting said information on the addressee of fee billing and said password to said external server;
second output means for outputting, to said image processing apparatus, said information on the address of fee billing according to a result of identification on said information on the addressee of fee billing and on said password in said external server;
second input means for entering information based on the output of image from said image processing apparatus; and
third output means for outputting information based on the output of said image to said external server.

10. An information processing apparatus according to claim 9, wherein said information on the addressee of fee billing includes information for specifying a company issuing a credit card, and information for specifying a user of said credit card.

11. An information processing apparatus according to claim 9, wherein said information on the addressee of fee billing includes information for specifying a bank issuing a debit card, and information for specifying a user of said debit card.

12. An information processing apparatus according to claim 9, wherein said second output means further outputs information for enabling activation of said image processing apparatus.

13. An image processing system composed of an information communication apparatus capable of communicating with an external server and an image processing apparatus, wherein:
said image processing apparatus includes:
first input means for entering information on an addressee of fee billing from said information communication apparatus;
second input means for entering an image;
addition means for adding said information on the addressee of fee billing to said image in a manner not easily recognizable to human eyes; and
first output means for outputting said added image; and
said information communication apparatus includes:
third input means for entering information on the addressee of fee billing and a password;
third output means for outputting said information on the addressee of fee billing and said password to said external server;
fourth output means for outputting, to said image processing apparatus, said information on the addressee of fee billing according to the result of identification on said information on the addressee of fee billing and on said password in said external server;
fourth input means for entering information based on the output of image from said image processing apparatus; and
fifth output means for outputting information based on the output of said image to said external server.

14. An image processing method in an image processing apparatus connected with an information communication apparatus, the method comprising:
a first input step of entering information on the addressee of fee billing from said information communication apparatus;
a second input step of entering an image;
an addition step of adding said information on the addressee of fee billing to said image in a manner not easily recognizable to human eyes; and
an output step of outputting said added image.

15. An information communication method in an information communication apparatus connected with an image processing apparatus and capable of communicating with an external server, the method comprising:
a first input step of entering information on an addressee of fee billing and a password;
a first output step of outputting said information on the addressee of fee billing and said password to said external server;
a second output step of outputting, to said image processing apparatus, said information on the addressee of fee billing according to the result of identification on said information on the addressee of fee billing and on said password in said external server;
a second input step of entering information based on the output of image from said image processing apparatus; and
a third output step of outputting information based on the output of said image to said external server.

16. A computer readable storage medium storing program codes in an image processing apparatus connected with an information communication apparatus, the medium comprising:
a first input code for entering information on the addressee of fee billing from said information communication apparatus;
a second input code for entering an image;
an addition code for adding said information on the addressee of fee billing to said image in a manner not easily recognizable to human eyes; and
an output code for outputting said added image.

17. A computer readable storage medium storing program codes in an information communication apparatus connected with an image processing apparatus and capable of communicating with an external server, the medium comprising:
a first input code for entering information on an addressee of fee billing and a password;
a first output code for outputting said information on the addressee of fee billing and said password to said external server;
a second output code for outputting, to said image processing apparatus, said information on the addressee of fee billing according to the result of identification on said information on the addressee of fee billing and on said password in said external server;
a second input code for entering information based on the output of image from said image processing apparatus; and
a third output code for outputting information based on the output of said image to said external server.

18. An image processing apparatus in which a server apparatus and a manager terminal apparatus are capable of communication through a predetermined communication medium and which controls execution of image processing by confirming fee payment charged for a predetermined image processing, comprising:
a card reader for reading a card medium in which recorded is personal identification information for identifying a person requesting the image processing;
conversion means for converting said personal identification information, read by said card reader, into personal identification image data;
image generation means for generating output image data to be outputted, from said personal identification image data converted by said conversion means and said user requested image data requested by the user for image processing; and
control means for limiting the request for image processing by comparing said personal identification information read by said card reader and image output limited person information on the person for whom image output is limited, acquired from said server apparatus.

19. An image processing apparatus according to claim 18, wherein said request for image processing is a request for copying.

20. An image processing apparatus according to claim 18, wherein said card reader is capable of reading different card media.

21. An image processing apparatus according to claim 18, wherein said card medium is an automobile driving license.

22. An image processing apparatus according to claim 18, wherein said card medium is a prepaid card issued under a condition of inscription of predetermined personal information.

23. An image processing apparatus according to claim 18, wherein said conversion means converts said personal identification information read by said card reader into invisible or scarcely visible personal identification image data.

24. An image processing apparatus according to claim 18, wherein said image generation means generates output image data to be outputted, by superposing said personal identification image data converted by said conversion means with said user requested image data requested for image processing.

25. An image processing apparatus according to claim 18, wherein said card reader is capable of reading a character on the card medium.

26. An image processing apparatus according to claim 18, wherein said card reader is capable of reading a numeral on the card medium.

27. An image processing apparatus according to claim 18, wherein said card reader is capable of reading a pattern on the card medium.

28. An image processing apparatus according to claim 18, wherein said card reader is capable of reading a registration number recorded on a magnetic card medium through a magnetic head.

29. An image processing apparatus according to claim 18, further comprising first informing means adapted, in case said control means compares said personal identification information read by said card reader with said memorized image output limited person information and identifies lack of coincidence therebetween, to inform the server apparatus through a predetermined communication medium, of improper person information indicating an improper person for the image request.

30. An image processing apparatus according to claim 18, further comprising second informing means adapted, in case said control means compares said personal identification information read by said card reader with said memorized image output limited person information and identifies lack of coincidence therebetween, to inform the manager terminal apparatus through a predetermined communication medium, of improper person alarm information indicating an improper person for the image request.

31. A managing method for an image processing apparatus which is connected to a card reader for reading a card medium recording personal identification information for identifying a person requesting image processing, in which a server apparatus and a manager terminal apparatus are capable of communication through a predetermined communication medium and which controls execution of image processing by confirming fee payment charged for a predetermined image processing, the method comprising:
a conversion step of converting said personal identification information, read by said card reader, into personal identification image data;
an image generation step of generating output image data to be outputted, from said personal identification image data converted by said conversion step and said user requested image data requested by the user for image processing; and
a control step of limiting the request for image processing by comparing said personal identification information read by said card reader and image output limited person information on the person for whom image output is limited, acquired from said server apparatus.

32. A computer readable storage medium for an image processing apparatus which is connected to a card reader for reading a card medium recording personal identification information for identifying a person requesting image processing, in which a server apparatus and a manager terminal apparatus are capable of communication through a predetermined communication medium and which controls execution of image processing by confirming fee payment charged for a predetermined image processing, the medium comprising:
a code for converting said personal identification information, read by said card reader, into personal identification image data;
a code for generating output image data to be outputted, from said converted personal identification image data and user requested image data requested by the user for image processing; and
a code for limiting the request for image processing by comparing said personal identification information read by said card reader and image output limited person information on the person for whom image output is limited, acquired from said server apparatus.

33. An image processing apparatus comprising:
input means for entering an image;
input means for entering predetermined information to be embedded in said image;
inquiry means for inquiring to the exterior whether said predetermined information is effective; and
embedding means for embedding said predetermined information into said image in case said inquiry means identifies that said predetermined information is effective.

34. An image processing apparatus according to claim 33, wherein said exterior is a server computer.

35. An image processing apparatus according to claim 33, wherein said inquiry means inquires through a communication channel whether said predetermined information is effective.

36. An image processing method comprising:
an input step of entering an image;
an input step of entering predetermined information to be embedded in said image;
an inquiry step of inquiring to the exterior whether said predetermined information is effective; and
an embedding step of embedding said predetermined information into said image in case said inquiry step identifies that said predetermined information is effective.

37. A computer readable storage medium comprising:
an input code for entering an image;
a code for entering predetermined information to be embedded in said image;
a code for inquiring to the exterior whether said predetermined information is effective; and
a code for embedding said predetermined information into said image in case said inquiry identifies that said predetermined information is effective.
